(19) United States
(12) Patent Application Publication
(10) Pub. No.: US 2016/0238628 A1
(43) Pub. Date: Aug. 18, 2016

(54) Motor Speed Probe with Integral Accelerometers

(71) Applicant: Electro-Motive Diesel, Inc., LaGrange, IL (US)

(72) Inventor: George Maier, Warrenville, IL (US)

(73) Assignee: Electro-Motive Diesel, Inc., LaGrange, IL (US)

(21) Appl. No.: 14/625,272

(22) Filed: Feb. 18, 2015

(51) Int. Cl. G01P 3/44; G01M 99/00; G01P 15/00

(52) U.S. Cl. CPC G01P 3/44; G01P 15/00; G01M 99/004

(57) ABSTRACT

A traction motor speed probe may include one or more accelerometers that report acceleration in three dimensions. The accelerometer signals may be compared to accelerometer signals associated with known conditions in either the motor or a machine on which the motor is operating, such as wheel lock-up, worn motor parts, or a flat spot on a wheel in a locomotive application. The accelerometer may also be useful in identifying when a zero reading from a speed sensor is because the motor speed probe is no longer firmly coupled to the motor or if motor or wheel are locked up.

### TECHNICAL FIELD

The present disclosure relates to a speed sensor for a motor and more particularly to a speed sensor with an integral accelerometer used for diagnostics of the motor and system in which the motor is installed.

### BACKGROUND

The accuracy of a speed sensor in a large motor, particularly a motor that is one of a set of motors used in a locomotive, is critical to the operation of the motor and in balancing the output between the motors in the set. The speed sensor may be used to identify operating conditions such as wheel slip but may also report important failure conditions such as wheel lock-up. Wheel lock-up is a dangerous condition that requires a train to be brought to a stop to allow a visual inspection protocol can be performed to test the wheel and axle, costing both time and money in delays and personnel costs.

Failure of a speed sensor is generally interpreted as a wheel lock-up and requires the full locomotive visual inspection protocol to be performed to determine if the wheel is free or locked-up. A frequent cause of speed sensor failure is simply that the screws holding the motor speed probe with the sensor loosen or were never tightened properly so that the sensor moves out of position to make a reading. In a locomotive application, the probe/sensor is mounted on the motor behind one of the wheels making it difficult to access, especially outside a repair facility.

U.S. patent publication 2013/0342362 (the '362 publication) discloses are wireless unit for use in a rail car that includes, among other possibility sensors, an accelerometer. The wireless unit has a short range transmitter and a receiver. With one wireless unit on each car in a train, a daisy chain network connection can be created down a long train to a master site, e.g., on the locomotive, that communicates information from the wireless units and their associated sensors. The '362 publication fails to disclose the use of an accelerometer mounted integral to a speed probe on a motor to diagnose a faulty probe mounting and other machine conditions.

### SUMMARY OF THE DISCLOSURE

In one aspect of the disclosure a motor speed probe for use in a locomotive includes a housing, a speed sensor disposed in the housing, and an accelerometer disposed in the housing.

In another aspect of the disclosure, a system for diagnosing fault conditions in a locomotive having an electric motor includes a motor speed probe coupled to the motor. The motor speed probe may include a housing, a speed sensor and an accelerometer wherein both the speed sensor and the accelerometer are disposed in the housing. The system also includes a controller coupled to the motor speed probe, the controller including a processor and a memory having computer executable instructions. The computer executable instructions cause the processor to interpret the output of the speed sensor to determine a speed associated with the motor and to compare a signal output of the accelerometer with a stored signal to identify a fault condition in the locomotive.

In yet another aspect of the disclosure, a method of identifying fault conditions in a motor includes coupling a motor speed probe to the motor, the motor speed probe including a housing containing i) a speed sensor configured to measure a speed of the motor, and ii) an accelerometer configured to measure acceleration in three-axes. The method also includes receiving at a controller a first signal from the speed sensor that is used to determine the speed of the motor, receiving at the controller a second signal from the accelerometer that is used to determine motion in three dimensions of the housing, and comparing the second signal to a database of pre-determined signals associated with one or more fault conditions. The method further includes providing an alert via the controller when the second signal matches one or more the pre-determined signals.

### BRIEF DESCRIPTION OF THE DRAWINGS

FIG. 1 is a simplified block diagram of a locomotive;

FIG. 2 is a side view of a motor speed probe;

FIG. 3 is block diagram of a controller for use in the locomotive of FIG. 1;

FIGS. 4-7 are exemplary accelerometer output signals corresponding to different conditions; and

FIG. 8 is a flowchart of a method of monitoring for locomotive conditions with an accelerometer in a speed sensor.

### DETAILED DESCRIPTION

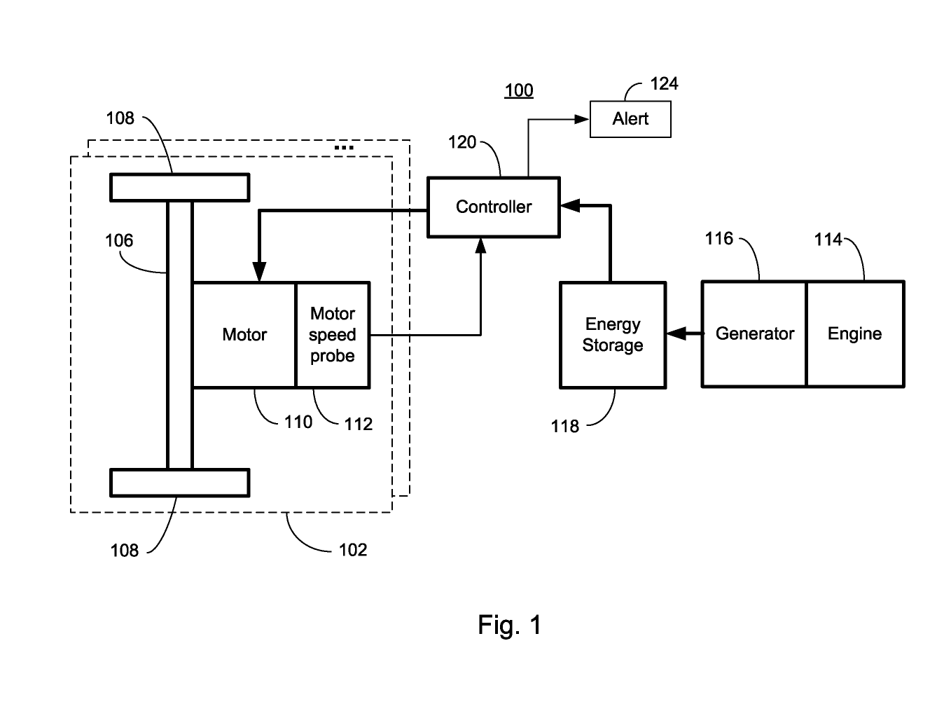

FIG. 1 is a simplified diagram of a machine 100, such as a locomotive. The machine 100 may include one or more trucks 102, sometimes called bogies, that include an axle 106 with two wheels 108, a motor 110 and a motor speed probe 112. There may be multiple trucks on a single machine. For example, some locomotives use 6 trucks. The motor 110 sometimes called a traction motor and may be a three phase alternating current motor, a switched reluctance motor, or other electric motor.

Mechanical energy generated by an engine 114 may be converted to electrical energy at a generator 116, with the electrical energy stored in an energy storage unit 118, such as a battery or capacitor bank. A controller 120 may be used to supply electrical energy stored in the energy storage unit 118 to the motor 110 based on load, track grade, and control signals from an operator cab (not depicted). For example, the controller 120 may calculate torque requirements and convert that information into signals for applying current to different phases of the motor 110 based on a position of a rotor or armature of the motor 110.

A motor speed probe 112 provides an indication of wheel speed to the controller 120. The motor speed probe 112 may also provide additional signals as described further below. The controller 120 may also provide a signal to an alert device 124 that provides an operator with an indication of a potential problem. The alert device 124 may have a light, an audible alarm or a combination of both. The controller 120 or the alert device 124 may also send a signal to a dispatcher or other maintenance facility. The alerts may include a notification of wheel lock-up.

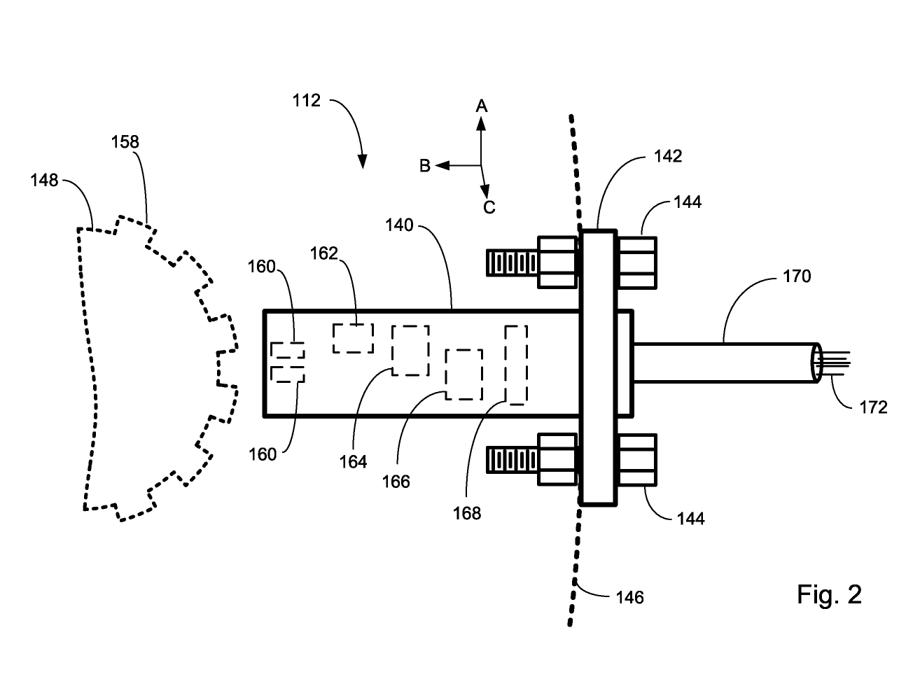

FIG. 2 is a side view of a motor speed probe 112. The motor speed probe 112 may include a housing 140 that may have an integral bracket 142 so that mounting bolts 144 can be used to secure the motor speed probe 112 to a motor frame 146. A speed wheel 148 may be attached to an armature shaft of the motor 110 so that one turn of the armature causes one rotation of the speed wheel 148. The ratio of the speed wheel 148 rotation to the axle 106 rotation may be known for use in converting speed wheel speed to speed. Rotation of the axle 106 and therefore the speed wheel 148 cause the teeth 158 on the speed wheel 148 to alter an electric field around the speed sensors 160, which in one embodiment are a Hall effect sensors. The altered field around the speed sensors 160 causes a pulse modulated signal to be developed which is carried via a wiring harness 170 with individual conductors 172 to the controller 120. Dual Hall effect sensors may be used to provide a direction indication by a comparison of the phase of the respective output signals, as well as to provide redundancy in speed sensing.

In addition to the speed sensors 160, the motor speed probe 112 may include an accelerometer 162 that reports acceleration in three dimensions to the controller 120 as indicated by the A, B, and C directional arrows. A power conditioner 164 may supply power to the accelerometer 162 while a power conditioner 166 may supply power to the speed sensors 160. Crosstalk noise between the accelerometer 162 and the speed sensors 160 may be minimized by using the separate power conditioners 164 and 166. The signal conditioner 168 may be used to separately buffer, drive, and/or impedance match the outputs of the speed sensors 160 and the accelerometer 162 for transmission to the controller 120.

The electrical components of the motor speed probe 112, that is the speed sensors 160, the accelerometer 162, the power conditioners 164, 166 and the signal conditioner 168 may be “potted” in the housing 140 using an epoxy resin or some other hardened compound to protect the wiring connections and components from damage caused by movement inside the housing 140 and from penetration by water, oil, or other contaminants. In addition, the electrical components themselves must be capable of surviving the high shock environment of a locomotive that uses steel wheels to ride on a steel track over joints, couplings, and switches.

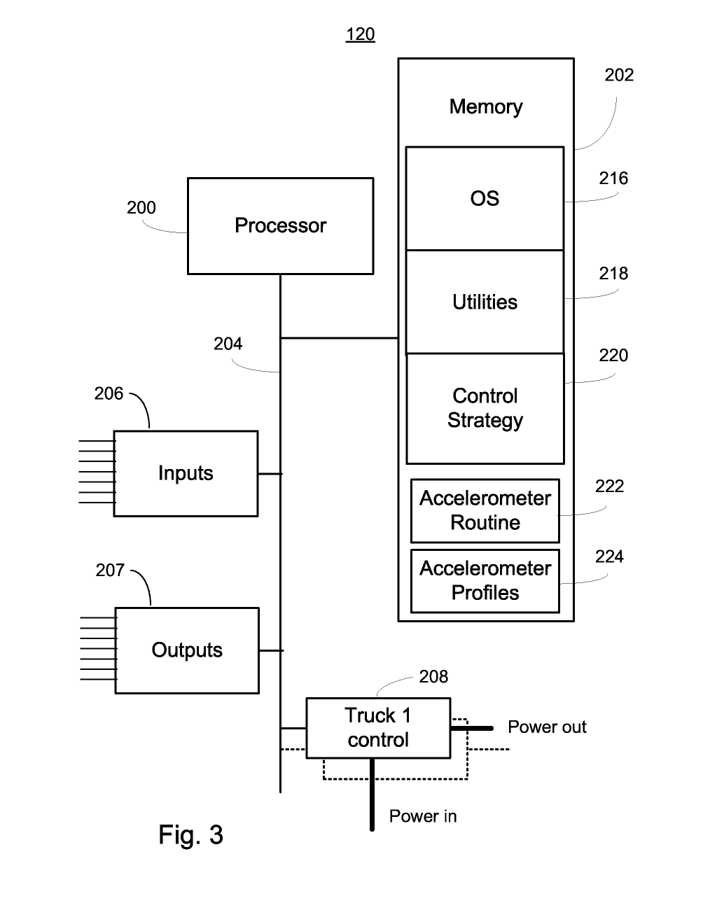

FIG. 3 is a block diagram of an exemplary controller 120 that may be used in the machine 100 of FIG. 1. The controller 120 may include a processor 200 and a memory 202 coupled by a data bus 204. The controller 120 may also include inputs 206 that receive signals from a number of sources including, but not limited to, operator controls, the motor speed probe 112, engine sensors, generator sensors, etc., used to implement a control strategy for operating the machine 100. The controller 120 may also include a number of outputs 207 that may drive, among other things, the alert device 124.

A truck control 208 may include a bank of high power semiconductor devices that control delivery of power from the energy storage device 118 to the motor 110 for a particular truck 102 of the machine 100.

The memory 202 may be any of several physical memories, including without limitation combinations of volatile and non-volatile RAM, ROM, flash, PROM, EEPROM or other memory technologies and constructions. The memory 202 is a physical memory and does not include carrier wave or other propagated media transient memories.

The memory 202 may include an operating system 216 and utilities 218 that are used to control, set up, and diagnose the overall operation of the controller 120. A control strategy 220 may analyze values of inputs 206 to determine a current state of the machine 100 as well as a desired state of the machine 100 and make adjustments to the power delivered to the motor 110, and in some cases, operation of the engine 114 and generator 116, to achieve the desired state.

The memory 202 may also include accelerometer routine 222 that analyzes the acceleration signals in three dimensions received from the accelerometer 162. The accelerometer routine 222, in an embodiment, may independently analyze a signal in each dimension to correlate patterns in the current signals to those stored in various accelerometer profiles 224. The correlation between current and known signals may involve a complex convolution process to align and identify matches in the signals to those anticipated for certain conditions.

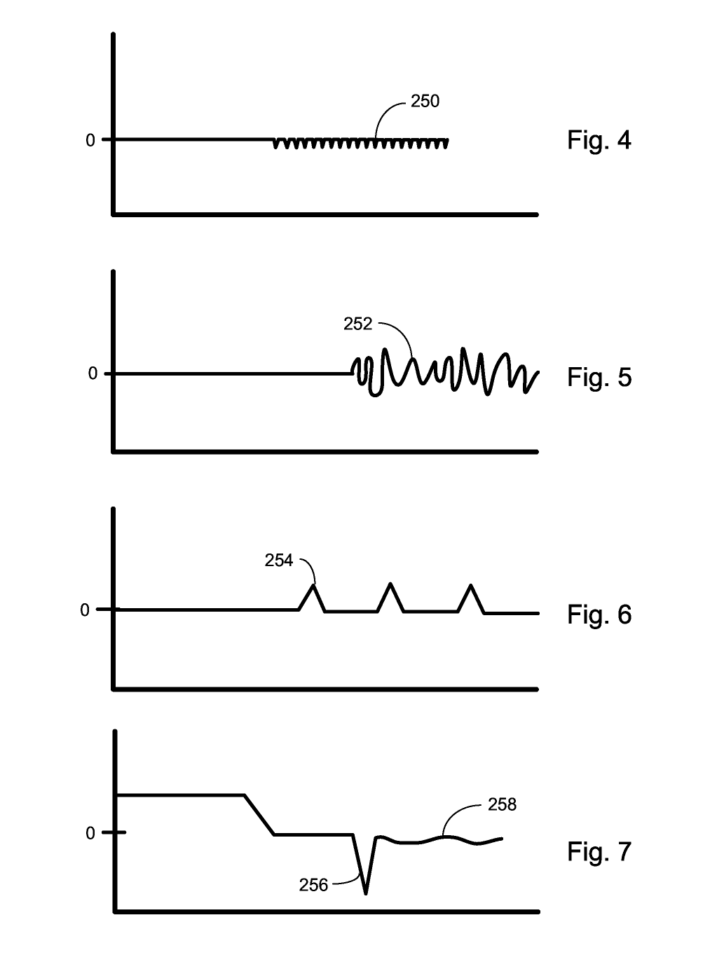

Turning to FIGS. 4-7 some exemplary accelerometer output signals corresponding to different conditions are illustrated. While the accelerometer 162 will experience routine acceleration in all directions, a filtering process may remove acceleration signal values associated with normal speed increases and decreases as well as single anomalies that may be associated with normal operation of the machine 100, such as passing over a railway switch or crossing. The exemplary signals shown in FIGS. 4-7 may be representative of acceleration in a single dimension, but may be a composite of signals for each of the three dimensions reported by the accelerometer 162. Of interest are those signals in any direction that are known to be indicators of an undesirable condition. FIG. 4 may illustrate a periodic pattern 250 in one dimension that may be associated with a worn motor bearing. For example, a cracked or flattened bearing may create a small acceleration or bump, each time the bearing rotates in its race.

FIG. 5 may illustrate a more random pattern 252 that may be indicative of the motor speed probe 112 having a loose mounting so that the motor speed probe 112 itself is shaking in one or more dimensions. When the motor speed probe 112 is not tightly coupled to the motor frame 146, a gap between the speed wheel teeth 158 and the speed sensors 160 may become too large to get an effective speed reading. This may cause an inaccurate speed reading, or in the worst case, no reading at all which is interpreted as wheel lock-up. FIG. 6 may illustrate a periodic pattern 254 associated with a flat spot on a wheel 108. Identification of such a pattern 254 as a flat spot may be aided by its period being related to the current speed of the machine 100.

FIG. 7 may illustrate a pattern 256 showing a sudden change in acceleration followed by a random change in acceleration indicated by pattern 258. The patterns 256 and 258 may be indicative of a wheel lock-up where the truck 102 decelerates as the wheel stops turning and then accelerates as the machine 100 overcomes the friction of the wheel 108 on the rail and drags the truck 102 unevenly. A combination of patterns 256 and 258 together with a low or zero speed signal from the speed sensors 160 may provide a cross-check that a wheel lock-up has occurred.

### INDUSTRIAL APPLICABILITY

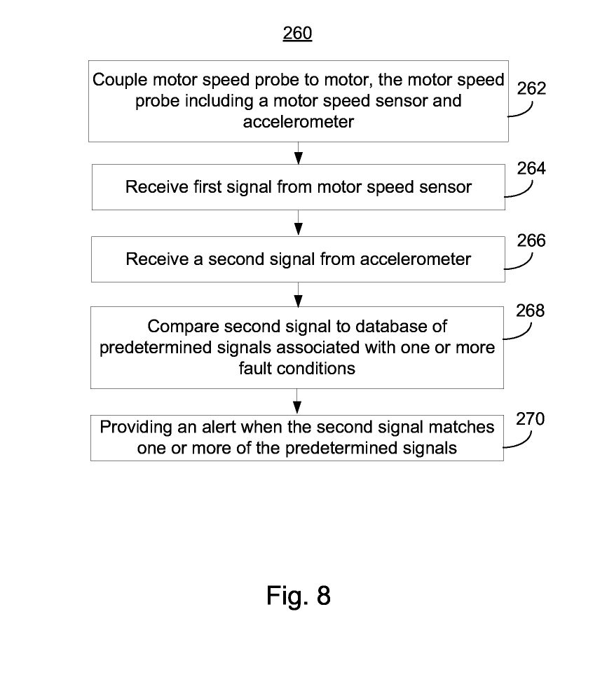

FIG. 8 is a flow chart 260 of a method of monitoring for locomotive conditions using an accelerometer 162 in a motor speed probe 112. At a block 262, the motor speed probe 112 may be coupled to a motor housing 146. The motor speed probe 112 may include a housing 140 containing i) one or more speed sensors 160, in one embodiment in the form of a Hall effect sensor, configured to measure a speed of the axle 106 and wheels 108, and ii) an accelerometer 162 configured to measure acceleration of the motor speed probe 112 in three axes. The speed sensors 160 may be any of a number of commercially available Hall effect sensor. The accelerometer 162 may be, for example, an ADXL377 accelerometer available from Analog Devices, Inc. The power conditioners 164 and 166 may be voltage regulators and may be provided to regulate power supplied to the accelerometer separate from any other power supplied to the motor speed probe. This helps avoid a condition where using a common voltage regulator could allow coupling of noise generated, for example, by the pulsed signals from the speed sensors 160. Additionally, output signals from the speed sensors 160 and the accelerometer 162 may be buffered or impedance matched before providing the respective output signals to the controller 120.

At a block 264, a first signal from one or both of the speed sensors 160 of the motor speed probe 112 may be received at a controller 120. The first signal may be a pulse coded signal where the pulse frequency is directly proportional to the speed of the speed wheel 148 and thereby also the rotational speed of the wheel 108. The first signal, that is, the speed signal may be used for any number of control and diagnostic functions including locomotive speed and power calculations, wheel slip estimation, engine 114 and generator 116 management, etc.

At a block 266, a second signal from accelerometer 162 of the motor speed probe 112 may also be received at the controller 120. The second signal may be directly related to acceleration in three dimensions of the motor speed probe 112. The second signal may be primarily used as a diagnostic indicator for the overall health of the truck 102. As shown above in the exemplary waveforms of FIGS. 4-7, any number of characteristics related to normal operation, trouble indicators, and failures in truck-related systems may be cataloged and used for future reference for diagnostics.

At a block 268, the second signal may be processed and compared to a database of pre-determined signals associated with normal operation as well as one or more fault conditions in the truck 102. These fault conditions may include, but are not limited to a faulty coupling of the motor speed probe 112 to the motor 110, a worn bearing in the motor 110; damage to an axle 106 coupled to the motor 110, a flat surface on a wheel 108 coupled to the motor 110, or a loss of lubricating fluid in the motor 110.

At a block 270, an alert device 124 may be activated via the controller 120 when the second signal matches one of more the pre-determined signals. The alert device 124 may include both visual and audible indicators to an operator of the locomotive as well as signal sent to remote locations both on and external to machine 100 and any train associated with the machine 100.

The ability to confirm wheel lock-up as well as the ability to diagnose other failures or potential failures through the use of an accelerometer 162 in the motor speed probe 112 provides a significant benefit to both locomotive manufacturers and railroad train operators. Railroad train operators benefit by reducing or eliminating unnecessary stoppages to identify false wheel lock-up conditions as well as receiving early warning on potentially harmful conditions such as flat wheels and motor bearing failures. Similarly locomotive manufacturers benefit by reduced warranty costs and increased customer satisfaction.

what is claimed is:

1. A motor speed probe comprising:
a housing;
a speed sensor disposed in the housing; and
an accelerometer disposed in the housing.

2. The motor speed probe of claim 1, further comprising a first voltage regulator that supplies power to the speed sensor and a second voltage regulator that supplies power to the accelerometer, the first voltage regulator electrically isolated from the second voltage regulator.

3. The motor speed probe of claim 1, wherein the speed sensor is a Hall effect sensor.

4. The motor speed probe of claim 1, wherein the accelerometer is a three-axis accelerometer.

5. The motor speed probe of claim 1, further comprising a wiring harness coupling the motor speed probe to outside power and signal connections.

6. The motor speed probe of claim 5, further comprising a signal conditioning circuit coupled between the accelerometer and the wiring harness.

7. A system for diagnosing fault conditions in a locomotive having an electric motor, the system comprising:
a motor speed probe coupled to the motor, the motor speed probe including a housing, a speed sensor and an accelerometer wherein both the speed sensor and the accelerometer are disposed in the housing;
a controller coupled to the motor speed probe, the controller including:
a processor; and
a memory having computer executable instructions that cause the processor to interpret the output of the speed sensor to determine a speed associated with the motor;
the memory having further computer executable instructions that cause the processor to compare a signal output of the accelerometer with a stored signal to identify a fault condition in the locomotive.

8. The system of claim 7, wherein the fault condition is a faulty attachment of the motor speed probe to the motor.

9. The system of claim 7, wherein the fault condition is worn bearing in the motor.

10. The system of claim 7, wherein the fault condition is damage to an axle coupled to the motor.

11. The system of claim 7, wherein the fault condition is a flat surface on a wheel driven by the motor.

12. The system of claim 7, wherein the fault condition is a locked wheel.

13. The system of claim 7, wherein the speed sensor is a Hall effect sensor and the accelerometer is a three-axis accelerometer.

14. The system of claim 7, wherein the motor speed probe further comprises a first voltage regulator that supplies power to the speed sensor and a second voltage regulator that supplies power to the accelerometer, the first voltage regulator electrically isolated from the second voltage regulator.

15. The system of claim 7, wherein the motor speed probe further comprises a wiring harness coupling an first output from the speed sensor to the controller and coupling a second output from the accelerometer to the controller.

16. A method of identifying fault conditions in a motor, the method comprising:
coupling a motor speed probe to the motor, the motor speed probe including a housing containing i) a speed sensor configured to measure a speed of the motor, and ii) an accelerometer configured to measure acceleration in three-axes;
receiving at a controller a first signal from the speed sensor that is used to determine the speed of the motor;
receiving at the controller a second signal from the accelerometer that is used to determine motion in three dimensions of the housing;
comparing the second signal to a database of pre-determined signals associated with one or more fault conditions; and
providing an alert via the controller when the second signal matches one or more the pre-determined signals.

17. The method of claim 16, further comprising:
regulating a voltage for the accelerometer separate from any other power supplied to the motor speed probe.

18. The method of claim 16, further comprising:
conditioning the first output signal and the second output signal before providing it to the controller.

19. The method of claim 16, wherein the one or more fault conditions includes a faulty coupling of the motor speed probe to the motor.

20. The method of claim 16, wherein the one or more fault conditions includes a worn bearing in the motor; damage to an axle coupled to the motor, a flat surface on a wheel coupled to the motor, or a loss of lubricating fluid in the motor.
